(19) United States
(12) Patent Application Publication
(10) Pub. No.: US 2023/0269743 A1
(43) Pub. Date: Aug. 24, 2023

(54) SCHEDULING DELAY DETERMINATION FOR EMTC

(71) Applicant: Lenovo (Beijing) Limited, Beijing (CN)

(72) Inventors: Zhi Yan, Xicheng District (CN); Hongmei Liu, Changping District (CN); Yuantao Zhang, Dongcheng District (CN); Yingying Li, Haidian District (CN); Haiming Wang, Xicheng District (CN)

(73) Assignee: Lenovo (Beijing) Limited, Beijing (CN)

(21) Appl. No.: 18/007,305

(22) PCT Filed: Aug. 5, 2020
(86) PCT No.: PCT/CN2020/107056

§ 371 Date: Jan. 30, 2023

(51) Int. Cl. H04W 72/23; H04W 72/1273; H04L 1/00

(52) U.S. Cl. CPC H04W 72/23; H04W 72/1273; H04L 1/0061

(57) ABSTRACT

Methods and apparatuses for determining scheduling delay for eMTC are disclosed. A method comprises receiving a control signal in a first time slot; receiving a data signal in a second time slot; and transmitting a feed-back of the data signal in a third time slot.

### FIELD

The subject matter disclosed herein generally relates to wireless communications, and more particularly relates to determining scheduling delay for eMTC.

### BACKGROUND

The following abbreviations are herewith defined, at least some of which are referred to within the following description: Third Generation Partnership Project (3GPP), European Telecommunications Standards Institute (ETSI), Frequency Division Duplex (FDD), Frequency Division Multiple Access (FDMA), Long Term Evolution (LTE), New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), Personal Digital Assistant (PDA), User Equipment (UE), Uplink (UL), Evolved Node B (eNB), Next Generation Node B (gNB), Downlink (DL), Central Processing Unit (CPU), Graphics Processing Unit (GPU), Field Programmable Gate Array (FPGA), Dynamic RAM (DRAM), Synchronous Dynamic RAM (SDRAM), Static RAM (SRAM), Liquid Crystal Display (LCD), Light Emitting Diode (LED), Organic LED (OLED), Orthogonal Frequency Division Multiplexing (OFDM), Radio Resource Control (RRC), Time-Division Duplex (TDD), Time Division Multiplex (TDM), User Entity/Equipment (Mobile Terminal) (UE), Uplink (UL), Universal Mobile Telecommunications System (UMTS), Worldwide Interoperability for Microwave Access (WiMAX), Internet-of-Things (IoT), Physical Downlink Shared Channel (PDSCH), Physical Uplink Shared Channel (PUSCH), Downlink control information (DCI), machine-type communication (MTC), enhanced MTC (eMTC), MTC Physical Downlink Control Channel (MPDCCH), Hybrid Automatic Repeat reQuest (HARQ), Half-Duplex FDD (HD-FDD), bandwidth limited/coverage enhancement (BL/CE), acknowledgement (ACK), negative acknowledgement (NACK), Radio Network Tempory Identity (RNTI), Cyclic Redundancy Check (CRC).

FIG. 1 illustrates the principal of eMTC HD-FDD data transmission in a transmission bundle. As shown in FIG. 1, subframes #0 to #16 are a transmission bundle for downlink control signal transmission, downlink data signal transmission and the corresponding feedback (ACK or NACK) transmission. Each transmission bundle includes downlink (DL) control channel (e.g., MPDCCH), DL data channel (e.g., PDSCH), switching gap between DL and UL, and uplink (UL) feedback channel (e.g., PUSCH or PUCCH). In FIG. 1, “M” is short for control signal (e.g. DCI) transmitted in MPDCCH; “D” is short for data signal scheduled by the control signal transmitted in PDSCH; and “U” is short for uplink feedback of the scheduled data signal transmitted in PUCCH or PUSCH. As shown in FIG. 1, in subframes #0 to #9, control signals can be transmitted in MPDCCH; in subframes #2 to #11, data signals scheduled by the control signals are transmitted in PDSCH; and in subframes #13 to #15, feedbacks of the data signals can be scheduled to be transmitted in PUCCH or PUSCH. Subframes #12 and #16 are used for uplink-downlink switching.

For a downlink data transmission process, the following steps are included. First, a control signal (such as DCI) is transmitted in a downlink control channel (e.g. MPDCCH) to schedule data signals transmitted in a downlink data channel (e.g. PDSCH). The data signals are transmitted in a subframe that is 2-subframes later than the subframe in which the control signal is completely transmitted. That is, the PDSCH scheduling delay is 2 subframes. For example, the control signal transmitted in subframe #0 schedules the data signals transmitted in subframe #2 (indicated as “+2” in FIG. 1). The data signals are transmitted in unit of TB. One TB is transmitted in one subframe. Afterwards, a feedback (ACK or NACK) of the data signals is transmitted in a uplink feedback channel (e.g. PUCCH or PUSCH) to indicate whether the corresponding data signals are correctly received (i.e. ACK) or not (i.e. NACK) at the UE side. In particular, one bit is used to indicate whether the data signals in a TB are correctly received at the UE. For example, ‘1’ represents ACK while ‘0’ represents NACK. The subframe(s) to transmit the feedbacks may be also determined by the control signal (DCI) scheduling the data signals. For example, the feedback for data signals transmitted in subframe #2 may be configured, by the control signal (transmitted in subframe #0) scheduling the data signal, e.g., to be transmitted in subframe #13. In particular, a “HARQ-ACK delay” field in the control signal may indicate that the HARQ-ACK delay is 11, that is, the feedback of the data signals is transmitted in a subframe that is 11 subframes later than the subframe in which the data signal is transmitted (i.e. 2+11=13). For ease of discussion, the data signals transmitted in a subframe (time slot) are referred to as “data signal transmitted in a subframe”.

In the above-described steps, each downlink data transmission process is associated with a process number. For example, for process #0, the control signal transmitted in subframe #0 schedules the data signal transmitted in a TB in subframe #2; and the feedback of the process #0 (i.e. for the data signal transmitted in subframe #2) is transmitted in subframe #13. The feedback of the data signal is associated with the process number so that the eNB knows with which TB (or with which subframe) the feedback is associated. The process number may also be referred to as HARQ process number. The maximal number of HARQ processes is configured by higher layer signaling. For example, the maximal numbers of HARQ processes is configured to 10 (e.g. HARQ processes #0 to #9) in the example of FIG. 1.

As shown in FIG. 1, control signals are transmitted, respectively, in subframes #0 to #9. Data signals are transmitted, respectively, in subframes #2 to #11. In particular, each of the scheduled data transmission subframes is 2-subframes later than the corresponding control signal transmission subframe. Therefore, control signal is transmitted in subframe #0 and the corresponding scheduled data signal is transmitted in subframe #2; control signal is transmitted in subframe #1 and the corresponding scheduled data signal is transmitted in subframe #3; . . . ; and control signal is transmitted in subframe #9 and the corresponding data signal is transmitted in subframe #11.

In case of half duplex FDD eMTC, one subframe is necessary for switching from DL to UL (or from UL to DL). Subframe #12 is used for switching from DL to UL.

Subframes #13 to #15 are used for UL transmission. In particular, subframes #13 to #15 are used to transmit feedbacks (ACK or NACK) for each of data signals transmitted in subframes #2 to #11.

Subframe #16 is used for switching from UL to DL, since a control signal will be transmitted in the next subframe (i.e. subframe #17, or subframe #0 of the next bundle, not shown in FIG. 1).

As can be seen from the above, in the first two subframes of each transmission bundle, the UE cannot receive data (only control signal in MPDCCH allowed). Therefore, DL peak data rate is restricted. Incidentally, in subframes #10 and #11, i.e. the two subframes before the DL to UL switching subframe (subframe #12) (or three subframes before the first UL subframe (subframe #13)), no control signals are transmitted.

If maximal 1000 bits can be transmitted in one subframe, the data rate for each subframe is 1000 bits×10/17=588 bits per millisecond (i.e. 588 k bps), considering that one subframe is 1 millisecond.

FIG. 1 shows that three subframes (subframes #13 to #15) are used for feedbacks (ACK or NACK) for data signals transmitted in ten previous subframes (subframes #2 to #11). This is achieved by HARQ bundling.

When HARQ bundling is configured, the DL scheduling information contains a DCI field “TBs in Bundle” which holds the number of TBs in a HARQ bundle, e.g. 1 or 2 or 3 or 4. The HARQ bundle is feedback bundle for different HARQ processes corresponding to different TBs transmitted in different subframes. As shown in FIG. 2, U0, U1, U2 and U3, corresponding to feedbacks for TB0, TB1, TB2 and TB3 transmitted in subframes #2 to #5 (i.e. D0, D1, D2 and D3), are bundled in one HARQ bundle. That is, the feedbacks (ACK or NACK) of 4 TBs (transmitted in subframes #2 to #5) are contained in one HARQ bundle. If feedbacks of 4 TBs are contained in one HARQ bundle, the last HARQ bundle (or at least one of the HARQ bundles) may contain feedbacks of less than 4 TBs, for example, 2 TBs (i.e. U8 and U9) in FIG. 2.

As shown in FIG. 2, HARQ bundle in subframe #13 is a feedback obtained by performing AND operation for the feedbacks of processes #0 to #3 (i.e. data signals D0 to D3 transmitted in subframes #2 to #5 scheduled by control signals M0 to M3 transmitted in subframes #0 to #3). That is, U0 to U3 are feedbacks for D0 to D3, respectively. Each of U0 to U3 is ACK (‘1’) or NACK (‘0’). In subframe #13, one bit that is obtained by U0 AND U1 AND U2 AND U3 is transmitted. Only when all of U0 to U3 are ACK (1), U0 AND U1 AND U2 AND U3=ACK (‘1’). When any of U0 to U3 is NACK (‘0’), U0 AND U1 AND U2 AND U3=NACK (‘0’). Incidentally, HARQ bundle can be supported only in CE mode A without PDSCH repetition.

When HARQ bundling (and/or dynamic ACK timing) is configured by RRC, the HD-FDD DL scheduling information (i.e. downlink control information (DCI)) contains a DCI field “HARQ-ACK Delay” which indicates the subframes of delay between end of PDSCH transmission and start of feedback. The “HARQ-ACK Delay” field has three bits in DCI format 6-1A in LTE to indicate HARQ-ACK delays of {4-11} subframes, as shown in Table 1.

TABLE 1

| ‘HARQ-ACK | HARQ-ACK delay when |
|---|---|
| delay’ field in DCI | ‘ce-HARQ-AckBundling’ is set |
| 000 | 4 |
| 001 | 5 |
| 010 | 6 |
| 011 | 7 |
| 100 | 8 |
| 101 | 9 |
| 110 | 10 |
| 111 | 11 |

For example, as shown in FIG. 2, downlink data D0 is transmitted in subframe #2 while U0 (i.e. feedback for downlink data D0) is transmitted in subframe #13. The delay between D0 and U0, which is indicated in control signal in subframe #0 (control signal M0), is 11 (indicated as “+11” in FIG. 2) (i.e. ‘HARQ-ACK delay’ field in DCI of M0 is set to “111”). On the other hand, downlink data D3 is transmitted in subframe #5 while U3 (i.e. feedback for downlink data D3) is transmitted in subframe #13. The delay between D3 and U3, which is indicated in control signal in subframe #3 (control signal M3), is 8 (indicated as “+8” in FIG. 2) (i.e. ‘HARQ-ACK delay’ field in DCI of M3 is set to “100”).

FIG. 2 also illustrates that the PDSCH scheduling delay is 2 subframes, e.g., the delay between M0 and D0 is 2 (indicated as “+2” in FIG. 2). As a whole, in a downlink data transmission process, there are two delays: a first delay refers to the delay between control signal transmitted in MPDCCH and the data signal transmitted in PDSCH scheduled by the control signal, which can be referred to as “PDSCH scheduling delay”; and a second delay refers to the delay between the data signal transmitted in PDSCH and the feedback of the data signal transmitted in PUCCH or PUSCH, which can be referred to as “HARQ-ACK delay”. Traditionally, the PDSCH scheduling delay is always 2; and the HARQ-ACK delay can be configured by a 3-bit ‘HARQ-ACK delay’ field in the control signal, as shown in Table 1. In addition, UE is configured with HARQ ACK bundling by higher layer parameter ce-HARQ-AckBundling.

FIG. 3 shows a proposal to achieve transmission of data signals in the first two subframes of the transmission bundle. In the example of FIG. 3, the maximal number of HARQ processes is extended to 14 (i.e. there can be 14 processes). The control signals in subframes #10 and #11 (M10 and M11) schedule data signals in subframes #17 and #18 (D10 and D11), respectively, e.g., by using new HARQ process numbers #10 and #11. In subframes #27 and #28, new HARQ process numbers #12 and #13 are used by control signals (M12 and M13) to schedule data signals transmitted in subframes #34 and #35 (D12 and D13). The HARQ process numbers #10 and #11 cannot be re-used in subframes #27 and #28 because the feedbacks (ACK or NACK) for the HARQ process numbers #10 and #11 (U10 and U11) are received in subframes #30 and #31, respectively, i.e. they have not been received in subframes #27 and #28.

The increase of the maximal number of HARQ processes from 10 to 14 does not require an increase of the DCI field to indicate the HARQ process number. This is due to the fact that both 10 and 14 HARQ process numbers can be represented by a 4-bits field in DCI.

When the maximal number of HARQ processes is extended to 14 to support transmission of data signals in the first two subframes of the transmission bundle, the possible values for “PDSCH scheduling delay”, and the possible values for the “HARQ-ACK delay” need to be considered.

As shown in FIG. 1 or 2, when no data signals are transmitted in the first two subframes of the transmission bundle, the PDSCH scheduling delay is always 2. However, when data signals are transmitted in the first two subframes of the transmission bundle as shown in FIG. 3, the PDSCH scheduling delay may be 2 (e.g. for legacy HARQ process numbers #0 to #9) or 7 (e.g. for new HARQ process numbers #10 to #13). In particular, the control signals in subframes #10 and #11 schedule the data signals transmitted in subframes #17 and #18 by using HARQ process numbers #10 and #11, in which the PDSCH scheduling delay is 7. For example, FIG. 3 shows “+7” which means that the data signal D10 scheduled by control signal M10 in subframe #10 will be transmitted in subframe #17 (10+7=17). The control signals M12 and M13 in subframes #27 and #28 schedule data signals D12 and D13 transmitted in subframes #34 and #35 by using HARQ process numbers #12 and #13, in which the PDSCH scheduling delay is also 7 (34-27, or 35-28). On the other hand, the control signals M0 to M9 in subframes #0 to #9 schedule data signals D0 to D9 transmitted in subframes #2 to #11 by using HARQ process numbers #0 to #9, in which the PDSCH scheduling delay is 2. The control signals M0 to M9 in subframes #17 to #26 schedule data signals D0 to D9 transmitted in subframes #19 to #28 by re-using HARQ process numbers #0 to #9, in which the PDSCH scheduling delay is also 2. For example, FIG. 3 shows “+2” which means that the data signal D0 scheduled by control signal M0 in subframe #0 will be transmitted in subframe #2 (0+2=2). Therefore, since there are two possible values (2 and 7) for the PDSCH scheduling delay, it is necessary to use one additional bit in the control signal (DCI) to indicate whether the PDSCH scheduling delay is 2 or 7, when 14 process numbers are supported so that transmission of data signals in the first two subframes of the transmission bundle can be achieved.

In addition, the HARQ-ACK delays of {4-11} subframes are not applicable when the maximal number of HARQ processes is extended to 14, since the HARQ-ACK delay for some data signals (e.g. D10) is at least 13 (if the feedback U10 is transmitted in subframe #30) as can be seen from FIG. 3.

Therefore, a new range ‘Range2’ is defined for the situation that 14 HARQ process numbers are supported, as shown in Table 2. The previous range of HARQ-ACK delays when ‘ce-HARQ-AckBundling’ is set is named as ‘Range1’.

TABLE 2

| | | HARQ-ACK delay |
|---|---|---|
| HARQ-ACK | HARQ-ACK delay when ‘ce- | when ‘ce-pdsch- |
| delay’ field | HARQ-AckBundling’ is set | fourteenProcesses’ is set |
| in DCI | ‘Range 1’ | ‘Range 2’ |
| 000 | 4 | 4 |
| 001 | 5 | 5 |
| 010 | 6 | 6 |
| 011 | 7 | 7 |
| 100 | 8 | 9 |
| 101 | 9 | 11 |
| 110 | 10 | 13 |
| 111 | 11 | 15 |

As can be seen from Table 2, a new column is added to list the HARQ-ACK delays corresponding to each ‘HARQ-ACK delay’ field in DCI. In particular, in ‘Range2’, values 8 and 10 are removed while 13 and 15 are added. So, the new range ‘Range2’ is {4, 5, 6, 7, 9, 11, 13, 15}.

When the maximum number of HARQ processes is extended to 14, data transmission is supported in the first two subframes of each transmission bundle. Therefore, the data rate for each subframe will be increased to 1000 bits×12/17=706 bits per millisecond (i.e. 706 k bps).

However, as described above, one additional bit is necessary to be added in the control signal (DCI) to indicate whether the PDSCH scheduling delay is 2 or 7.

It is an object of the present application to propose solutions for improving the determination of the PDSCH scheduling delay for eMTC.

### BRIEF SUMMARY

Methods and apparatuses of the present application are disclosed.

In one embodiment, a method comprises receiving a control signal in a first time slot; receiving a data signal in a second time slot; and transmitting a feedback of the data signal in a third time slot.

In one embodiment, the second time slot is equal to the first time slot plus a first time delay, and the third time slot is equal to the second time slot plus a second time delay.

In some embodiment, the control signal includes a scheduling delay field that indicates both the first time delay and the second time delay.

In some embodiment, the second time slot is two DL time slots after the first time slot except scheduled uplink time slot(s) and uplink-downlink switching time slot(s). Alternatively, the second time slot is the first time slot plus two time slots or seven time slots, which is determined by the presence or non-presence of at least one DL time slot between the first time slot plus N time slot(s) and a first scheduled uplink time slot minus N time slot(s), wherein N is 1 or 2.

In some embodiment, the first time delay is determined by a RNTI value corresponding to the control signal. Alternatively, the first time delay is determined by a CRC mask corresponding to the control signal.

In one embodiment, a remote unit comprises a receiver that receives a control signal in a first time slot and receives a data signal in a second time slot; and a transmitter that transmits a feedback of the data signal in a third time slot.

In another embodiment, a method comprises transmitting a control signal in a first time slot; transmitting a data signal in a second time slot; and receiving a feedback of the data signal in a third time slot.

In yet another embodiment, a base unit comprises a transmitter that transmits a control signal in a first time slot and transmits a data signal in a second time slot; and a receiver that receives a feedback of the data signal in a third time slot.

### BRIEF DESCRIPTION OF THE DRAWINGS

A more particular description of the embodiments briefly described above will be to rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 is a schematic diagram illustrating a prior art downlink data transmission;

FIG. 2 is a schematic diagram illustrating a HARQ bundling;

FIG. 3 is a schematic diagram illustrating a proposal of downlink data transmission supporting 14 process numbers;

FIG. 4 illustrates the concept of logic DL subframes;

FIG. 5 is a schematic flow chart diagram illustrating an embodiment of a method;

FIG. 6 is a schematic flow chart diagram illustrating a further embodiment of a method; and

FIG. 7 is a schematic block diagram illustrating apparatuses according to one embodiment.

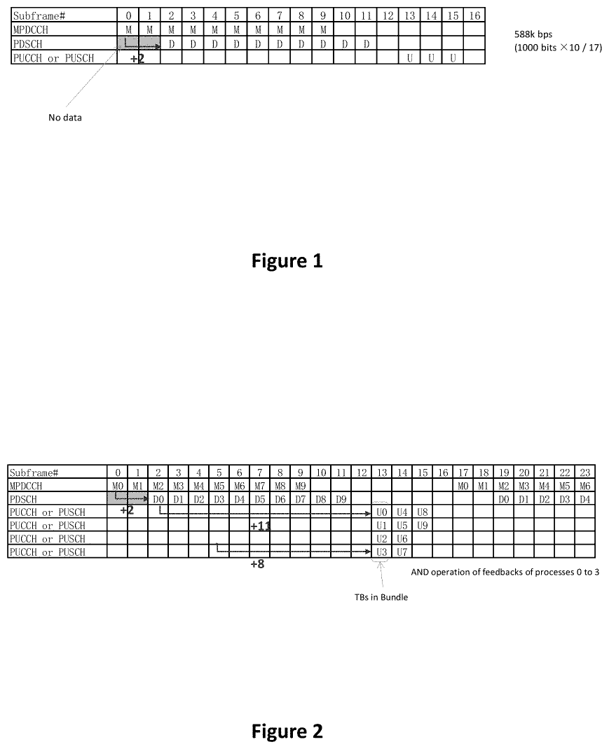

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

As described in the background part, in order to support 14 process numbers, one additional bit is added in the control signal (DCI) to indicate whether the PDSCH scheduling delay is 2 or 7. In addition, the set of HARQ-ACK delays is modified to a range of {4, 5, 6, 7, 9, 11, 13 and 15}.

According to a first embodiment, the one additional bit for indicating whether the PDSCH scheduling delay is 2 or 7 can be eliminated, while the indication of whether the PDSCH scheduling delay is 2 or 7 is still achieved. This is done by considering the relation between the HARQ-ACK delay and the PDSCH scheduling delay.

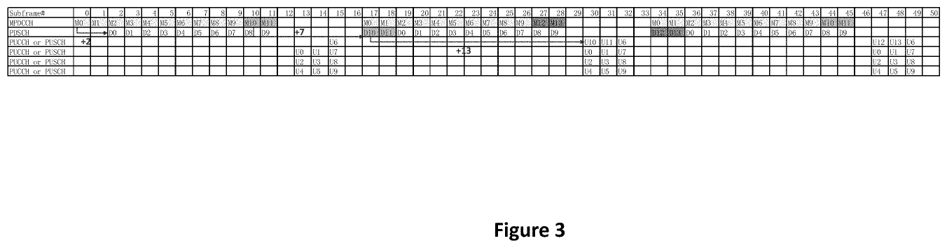

The relation of subframe number for control signal, subframe number for data signal, possible subframe number(s) for feedback (HARQ-ACK) for each process number of FIG. 3 is listed in Table 3. The PDSCH scheduling delay (obtained by “subframe number for data signal”−“subframe number for control signal”) and the possible HARQ-ACK delay (obtained by “possible subframe number for HARQ-ACK”−“subframe number for data signal”) are also listed in Table 3.

TABLE 3

| | | | | Possible | |
|---|---|---|---|---|---|
| | Subframe# | Subframe# | PDSCH | Subframe# | Possible |
| Process | for control | for data | scheduling | for HARQ- | HARQ-ACK |
| number | signal | signal | delay | ACK | delay |
| 0 | 0 | 2 | 2 | 13 14 15 | 11 12 13 |
| 1 | 1 | 3 | 2 | 13 14 15 | 10 11 12 |
| 2 | 2 | 4 | 2 | 13 14 15 | 9 10 11 |
| 3 | 3 | 5 | 2 | 13 14 15 | 8 9 10 |
| 4 | 4 | 6 | 2 | 13 14 15 | 7 8 9 |
| 5 | 5 | 7 | 2 | 13 14 15 | 6 7 8 |
| 6 | 6 | 8 | 2 | 13 14 15 | 5 6 7 |
| 7 | 7 | 9 | 2 | 13 14 15 | 4 5 6 |
| 8 | 8 | 10 | 2 | 14 15 | 4 5 |
| 9 | 9 | 11 | 2 | 15 | 4 |
| 10 | 10 | 17 | 7 | 30 31 32 | 13 14 15 |
| 11 | 11 | 18 | 7 | 30 31 32 | 13 14 15 |
| 12 | 27 | 34 | 7 | 47 48 49 | 13 14 15 |
| 13 | 28 | 35 | 7 | 47 48 49 | 13 14 15 |

It can be seen from Table 3 that, when the HARQ-ACK delay is any of 4 to 12, the PDSCH scheduling delay is definitely 2, and when the HARQ-ACK delay is any of 13 to 15, the PDSCH scheduling delay is most probably 7, with only one exception. The only one exception is for the control signal transmitted in subframe #0 scheduling the data signal transmitted in subframe #2: the HARQ-ACK feedback for the data signal transmitted in subframe #2 may be scheduled to any one of subframes #13 to #15. When the HARQ-ACK feedback for the data signal transmitted in subframe #2 is scheduled to be transmitted in subframe #15, the HARQ-ACK delay would be 13 while the PDSCH scheduling delay is 2.

Nevertheless, as the control signal M0 is transmitted in subframe #0 (the first subframe) scheduling the data signal D0 transmitted in subframe #2, it is most probably logical to schedule the feedback U0 for the data signal D0 to be transmitted in a first possible UL subframe (i.e. subframe #13) instead the last possible UL subframe #15. For example, each underlined possible subframe number for HARQ-ACK indicates the value shown in FIG. 3, in which the subframe number for HARQ-ACK for the data signal transmitted in subframe #2 is subframe #13, and accordingly the HARQ-ACK delay is 11 (=13-2). As a whole, when the HARQ-ACK delay is determined as one of {4, 5, 6, 7, 9, 11} (8, 10 and 12 do not belong to ‘Range2”), the PDSCH scheduling delay can be determined accordingly as 2; and when the HARQ-ACK delay is determined as one of {13, 15} (14 does not belong to ‘Range2”); the PDSCH scheduling delay can be determined with a high possibility as 7.

For each “HARQ-ACK delay” field in DCI shown in Table 2 with the HARQ-ACK delay when 14 process numbers are supported, the corresponding PDSCH scheduling delay in Table 3 is further shown in Table 4, in view of the above analysis.

TABLE 4

| | HARQ-ACK delay when | PDSCH |
|---|---|---|
| HARQ-ACK delay’ | ‘ce-pdsch- | scheduling |
| field in DCI | fourteenProcesses’ is set | delay |
| 000 | 4 | 2 |
| 001 | 5 | 2 |
| 010 | 6 | 2 |
| 011 | 7 | 2 |
| 100 | 9 | 2 |
| 101 | 11 | 2 |
| 110 | 13 | 7 |
| 111 | 15 | 7 |

Table 4 shows that, when 14 HARQ processes are configured, the HARQ-ACK delay field in DCI can indicate simultaneously both the HARQ-ACK delay and PDSCH scheduling delay. In particular, if the HARQ-ACK delay filed is “110” or “111”, the PDSCH scheduling delay is 7, otherwise (if the HARQ-ACK delay filed is any of “000”, “001”, “010”, “011”, “100” and “101”), the PDSCH scheduling delay is 2. According to Table 4, the possibility of the “only one exception” (i.e. the HARQ-ACK delay is 13 while the PDSCH scheduling delay is 2) is eliminated.

According to the first embodiment, the HARQ-ACK delay field in DCI can indicate simultaneously two different kinds of delays, i.e. HARQ-ACK delay and PDSCH scheduling delay. Therefore, the one additional bit for indicating whether the PDSCH scheduling delay is 2 or 7 is unnecessary.

According to a second embodiment, when 14 HARQ processes are configured, a data signal is transmitted two subframes after the subframe in which a control signal scheduling the data signal is transmitted except the scheduled uplink subframes and the uplink-downlink switching subframes.

With reference to FIG. 3, UE receives a control signal (DCI) M10 in subframe #10, the transmission of data signal D10 is in subframe #17, which is two subframes after subframe #10 (except the scheduled uplink subframes #13, #14 and #15 and the uplink-downlink switching subframes #12 and #16).

In subframe #10, M6 has been detected. Accordingly, the UE knows that U6 (the feedback for D6 scheduled by M6) is scheduled in subframe #15. Therefore, the UE can assume that subframes #13 to #15 are uplink HARQ-ACK subframes and accordingly, subframes #12 and #16 are uplink-downlink switching subframes. So, the subframe that is two subframes after the subframe in which a control signal scheduling the data signal is transmitted (in subframe #10) except the scheduled uplink subframes (#13, #14 and #15) and the uplink-downlink switching subframes (#12 and #16) is subframe #17. Therefore, the UE expects to receive the data signal D10 scheduled by the control signal M10 in subframes #17.

Subframes #0 to #50 are illustrated in FIG. 3. Some of the subframes (such as subframes #12 to #16, subframes #29 to #33, and subframes #46 to #50 in FIG. 3) can be scheduled as uplink subframes or uplink-downlink switching subframes. The subframes except uplink subframes and uplink-downlink switching subframes can be defined as “logic DL subframes”.

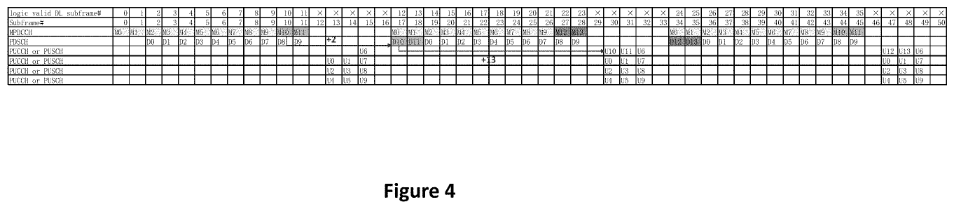

FIG. 4 illustrates the concept of logic DL subframes. Compared with FIG. 3, a row of “logic DL subframe #” is added. The label ‘×’ means that the subframe is not a logic DL subframe. Therefore, “two subframes after the subframe in which a control signal scheduling the data signal is transmitted except the scheduled uplink subframes and the uplink-downlink switching subframes” can be rewritten as “two logic DL subframes after the subframe in which a control signal scheduling the data signal is transmitted”. For example, with reference to FIG. 4, UE receives a control signal (DCI) M10 in subframe #10 (logic DL subframe #10), a data signal D10 scheduled by the control signal M10 is transmitted in subframe #17 (logic DL subframe #12), which is two logic DL subframes after subframe #10 (logic DL subframe #10) (indicated as “+2” in FIG. 4).

According to a third embodiment, when 14 HARQ processes are configured, the PDSCH scheduling delay being equal to 2 or 7 is determined by the presence or non-presence of subframe(s) between the subframe in which control signal is transmitted plus 1 subframe and the first scheduled uplink subframe minus 1 subframe. If there is at least one subframe between the subframe in which control signal is transmitted plus 1 subframe and the first scheduled uplink subframe minus 1 subframe, the PDSCH scheduling delay is 2. Otherwise, (if there is no subframe between the subframe in which control signal is transmitted plus 1 subframe and the first scheduled uplink subframe minus 1 subframe), the PDSCH scheduling delay is 7.

With reference to FIG. 3, UE receives a control signal (DCI) in subframe #10 to while the first scheduled uplink subframe is subframe #13. Therefore, the subframe in which control signal is transmitted (subframe #10) plus 1 subframe is subframe #11, and the first scheduled uplink subframe (subframe #13) minus 1 subframe is subframe #12. There is no subframe between subframe #11 and subframe #12 (as they are adjacent subframes). So, the PDSCH scheduling delay for the control signal in subframe #10 is 7, i.e. the data signal scheduled by the control signal in subframe #10 is transmitted in subframe #17 (=10+7).

As another example, UE receives a control signal (DCI) in subframe #9 while the first scheduled uplink subframe is subframe #13. Therefore, the subframe in which control signal is transmitted (subframe #9) plus 1 subframe is subframe #10, and the first scheduled uplink subframe (subframe #13) minus 1 subframe is subframe #12. There is one subframe (i.e. subframe #11) between subframe #10 and subframe #12. So, the PDSCH scheduling delay is 2, i.e. the data signal scheduled by the control signal transmitted in subframe #9 is transmitted in subframe #11 (=9+2).

The above explanation of the third embodiment describes that there is no subframe between subframe #11 and subframe #12, in which neither the subframe #11 nor the subframe #12 is considered as a subframe between subframe #11 and subframe #12. If a subframe #n is considered as a subframe between the subframe #n and another subframe, the above determination “the presence or non-presence of subframe(s) between the subframe in which control signal is transmitted plus 1 subframe and the first scheduled uplink subframe minus 1 subframe” can be rewritten as “the presence or non-presence of subframe(s) between the subframe in which control signal is transmitted plus 2 subframes and the first scheduled uplink subframe minus 2 subframes”. In particular, when the number of the subframe in which control signal is transmitted plus 2 subframes is equal to or smaller than the number of the first scheduled uplink subframe minus 2 subframes, there is at least one subframe between the subframe in which control signal is transmitted plus 2 subframes and the first scheduled uplink subframe minus 2 subframes. On the other hand, when the number of the subframe in which control signal is transmitted plus 2 subframes is larger than the number of the first scheduled uplink subframe minus 2 subframes, there is no subframe between the subframe in which control signal is transmitted plus 2 subframes and the first scheduled uplink subframe minus 2 subframes.

For example, UE receives a control signal (DCI) in subframe #9 while the first scheduled uplink subframe is subframe #13. Therefore, the subframe in which control signal is transmitted (subframe #9) plus 2 subframes is subframe #11, and the first scheduled uplink subframe (subframe #13) minus 2 subframes is subframe #11. There is one subframe (i.e. subframe #11) between subframe #11 and subframe #11. So, the PDSCH scheduling delay is 2, i.e. the data signal scheduled by the control signal transmitted in subframe #9 is transmitted in subframe #11 (=9+2).

As another example, UE receives a control signal (DCI) in subframe #10 while the first scheduled uplink subframe is subframe #13. Therefore, the subframe in which control signal is transmitted (subframe #10) plus 2 subframes is subframe #12, and the first scheduled uplink subframe (subframe #13) minus 2 subframes is subframe #11. As 12 is larger than 11, there is no subframe between subframe #12 and subframe #11. So, the PDSCH scheduling delay for the control signal in subframe #10 is 7, i.e. the data signal scheduled by the control signal in subframe #10 is transmitted in subframe #17 (=10+7).

According to a fourth embodiment, the PDSCH scheduling delay being equal to 2 or 7 is determined or further determined by the RNTI scrambled to the DCI format 6-1A.

UE is configured with two RNTIs. One is the legacy RNTI (e.g., C-RNTI) and another is a new RNTI (different from the legacy RNTI). UE expects to monitor the control signal (DCI) with the new RNTI only in the case that there is a scheduled uplink subframe for HARQ-ACK within 3 subframes from the subframe in which the control signal is transmitted.

For example, with reference to FIG. 3, a control signal M10 schedules a data signal D10. Within 3 subframes (i.e. in subframes #11, #12 and #13), there is a scheduled uplink subframe (i.e. subframe #13) (subframe #13 has been scheduled as uplink subframe for U0, U2 and U4 by control signals M0, M2 and M4 in subframes #0, #2 and #4, so the UE, at subframe #10 in which M10 is transmitted, knows that subframe #13 is a scheduled uplink subframe). Therefore, UE expects to monitor the DCI transmitted in M10 with the new RNTI, and accordingly assumes that the PDSCH scheduling delay for the control signal transmitted in subframe #10 is 7 (i.e. the data signal D10 scheduled by M10 is transmitted in subframe #17).

On the other hand, with reference to FIG. 3, a control signal M9 schedules a data signal D9. Within 3 subframes (i.e. in subframes #10, #11 and #12), there is no scheduled uplink subframe (subframe #13 has been scheduled as the earliest uplink subframe, so the UE knows that subframes #10, #11 and #12 are not scheduled uplink subframes). Therefore, UE expects to monitor the DCI transmitted in M9 with legacy RNTI (e.g., C-RNTI), and accordingly assumes that the PDSCH scheduling delay for the control signal transmitted in subframe #9 is 2 (i.e. the data signal D9 scheduled by M9 is transmitted in subframe #11).

As a whole, UE monitors a control signal (DCI) with the new RNTI (different RNTI from the legacy RNTI) only in the case that there is a scheduled uplink subframe for HARQ-ACK within 3 subframes from the subframe in which the control signal (DCI) is transmitted and assumes that the PDSCH scheduling delay is 7. On the other hand, UE monitors a control signal (DCI) with legacy RNTI in the case that there is no scheduled uplink subframe for HARQ-ACK within 3 subframes from the subframe in which the control signal (DCI) is transmitted and assumes that the PDSCH scheduling delay is 2.

Alternatively, the UE may make blind detection of all of control signals (DCIs) transmitted in MPDCCH with both RNTIs (both the legacy RNTI and the new RNTI). When the detection with the legacy RNTI is successful, the PDSCH scheduling delay is 2; and when the detection with the new RNTI is successful, the PDSCH scheduling delay is 7.

The fourth embodiment can be used independently to determine the PDSCH scheduling delay being equal to 2 or 7. Alternatively, the fourth embodiment can be used together with any of the first to the third embodiments to “double check” the PDSCH scheduling delay being equal to 2 or 7.

According to a variety of the fourth embodiment, RNTI can be replaced by CRC mask. One CRC mask (e.g. {0, 0 . . . 0}) is used in the case that there is no scheduled uplink subframe for HARQ-ACK within 3 subframes from the subframe in which the control signal (DCI) is transmitted, in which the UE assumes that the PDSCH scheduling delay is 2. Another CRC mask (e.g. {1, 1, . . . , 1}) different from the one CRC mask is used in the case that there is a scheduled uplink subframe for HARQ-ACK within 3 subframes from the subframe in which the control signal (DCI) is transmitted, in which the UE assumes that the PDSCH scheduling delay is 7.

Similarly, the variety of the fourth embodiment can be used independently, or alternatively used together with any of the first to the third embodiments.

All of the above embodiments are described in the context of “subframe”. A subframe is an example of a time slot.

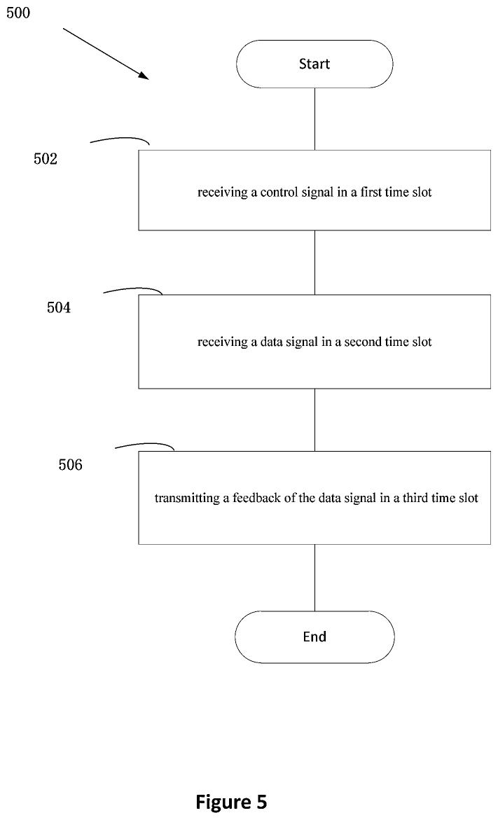

FIG. 5 is a schematic flow chart diagram illustrating an embodiment of a method 500 according to the present application. In some embodiments, the method 500 is performed by an apparatus, such as a remote unit. In certain embodiments, the method 500 may be performed by a processor executing program code, for example, a microcontroller, a microprocessor, a CPU, a GPU, an auxiliary processing unit, a FPGA, or the like.

The method 500 may include 502 receiving a control signal in a first time slot; 504 receiving a data signal in a second time slot; and 506 transmitting a feedback of the data signal in a third time slot.

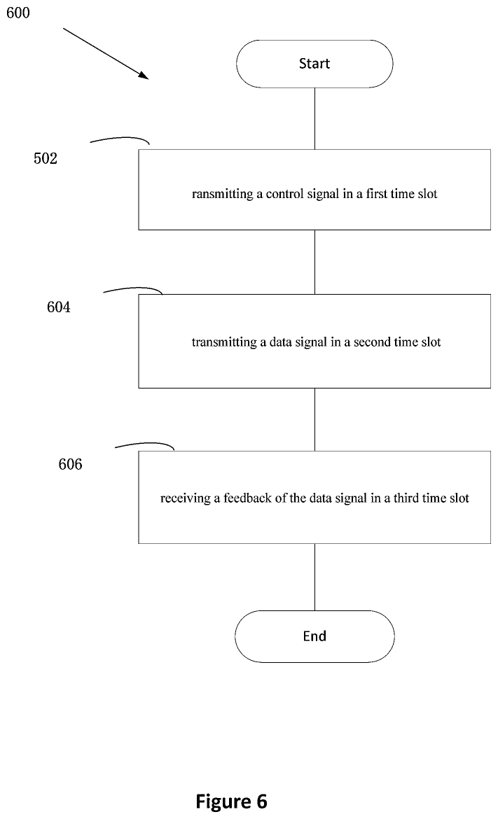

FIG. 6 is a schematic flow chart diagram illustrating a further embodiment of a method 600 according to the present application. In some embodiments, the method 600 is performed by an apparatus, such as a base unit. In certain embodiments, the method 600 may be performed by a processor executing program code, for example, a microcontroller, a microprocessor, a CPU, a GPU, an auxiliary processing unit, a FPGA, or the like.

The method 600 may include 602 transmitting a control signal in a first time slot; 604 transmitting a data signal in a second time slot; and 606 receiving a feedback of the data signal in a third time slot.

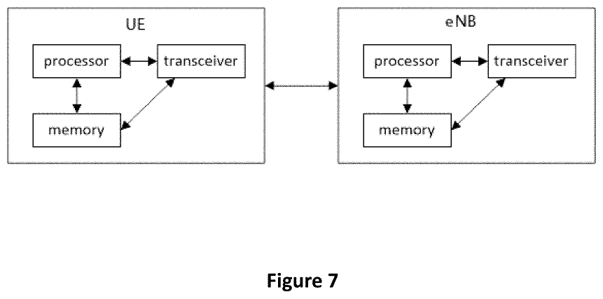

FIG. 7 is a schematic block diagram illustrating apparatuses according to one embodiment.

Referring to FIG. 7, the UE (i.e. the remote unit) includes a processor, a memory, and a transceiver. The processor implements a function, a process, and/or a method which are proposed in FIG. 5. The eNB (i.e. base unit) includes a processor, a memory, and a transceiver. The processors implement a function, a process, and/or a method which are proposed in FIG. 6. Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

1. A method comprising:
receiving a control signal in a first time slot;
receiving a data signal in a second time slot; and
transmitting a feedback of the data signal in a third time slot.

2. The method of claim 1, wherein, the second time slot is equal to the first time slot plus a first time delay, and the third time slot is equal to the second time slot plus a second time delay.

3. The method of claim 2, wherein, the control signal includes a scheduling delay field that indicates both the first time delay and the second time delay.

4. The method of claim 1, wherein the second time slot is two time slots after the first time slot except at least one scheduled uplink time slot and at least one uplink-downlink switching time slot.

5. The method of claim 1, wherein the second time slot is the first time slot plus two time slots or seven time slots, which is determined by a presence or non-presence of at least one time slot between the first time slot plus N time slot(s) and a first scheduled uplink time slot minus N time slot(s), wherein N is 1 or 2.

6. The method of claim 2, wherein, the first time delay is determined by a Radio Network Temporary Identity value corresponding to the control signal.

7. (canceled)

8. A remote unit, comprising:
a receiver to receive a control signal in a first time slot and to receive a data signal in a second time slot; and
a transmitter to transmit a feedback of the data signal in a third time slot.

9. The remote unit of claim 8, wherein, the second time slot is equal to the first time slot plus a first time delay, and the third time slot is equal to the second time slot plus a second time delay.

10. The remote unit of claim 9, wherein, the control signal includes a scheduling delay field that indicates both the first time delay and the second time delay.

11. The remote unit of claim 8, wherein the second time slot is two time slots after the first time slot except at least one scheduled uplink time slot and at least one uplink-downlink switching time slot.

12. The remote unit of claim 8, wherein the second time slot is the first time slot plus two time slots or seven time slots, which is determined by a presence or non-presence of at least one time slot between the first time slot plus N time slot(s) and a first scheduled uplink time slot minus N time slot(s), wherein N is 1 or 2.

13. The remote unit of claim 9, wherein, the first time delay is determined by a Radio Network Temporary Identity value corresponding to the control signal.

14. The remote unit of claim 9, wherein, the first time delay is determined by a Cyclic Redundancy Check mask corresponding to the control signal.

15. (canceled)

16. (canceled)

17. (canceled)

18. (canceled)

19. (canceled)

20. (canceled)

21. (canceled)

22. A base unit, comprising:
a transmitter to transmit a control signal in a first time slot and to transmit a data signal in a second time slot; and
a receiver to receive a feedback of the data signal in a third time slot.

23. The base unit of claim 22, wherein, the second time slot is equal to the first time slot plus a first time delay, and the third time slot is equal to the second time slot plus a second time delay.

24. The base unit of claim 23, wherein, the control signal includes a scheduling delay field that indicates both the first time delay and the second time delay.

25. The base unit of claim 22, wherein the second time slot is two time slots after the first time slot except at least one scheduled uplink time slot and at least one uplink-downlink switching time slot.

26. The base unit of claim 22, wherein the second time slot is the first time slot plus two time slots or seven time slots, which is determined by a presence or non-presence of at least one time slot between the first time slot plus N time slot(s) and a first scheduled uplink time slot minus N time slot(s), wherein N is 1 or 2.

27. The base unit of claim 23, wherein, the first time delay is determined by a Radio Network Temporary Identity value corresponding to the control signal.

28. The base unit of claim 23, wherein, the first time delay is determined by a Cyclic Redundancy Check mask corresponding to the control signal.
